(19) United States
(12) Patent Application Publication
(10) Pub. No.: US 2024/0192240 A1
(43) Pub. Date: Jun. 13, 2024

(54) TRANSPORT RACK, AUTOMATIC ANALYZING APPARATUS, AND AUTOMATIC ANALYZING SYSTEM

(71) Applicant: CANON MEDICAL SYSTEMS CORPORATION, Otawara-shi (JP)

(72) Inventors: Takeshi KINPARA, Utsunomiya (JP); Takafumi FUJIWARA, Nasushiobara (JP); Takahiro OMORI, Otawara (JP); Hideto KOJIMA, Nikko (JP); Yoshifumi YAMAGATA, Sakura (JP); Tomoaki KURANO, Nasushiobara (JP)

(73) Assignee: CANON MEDICAL SYSTEMS CORPORATION, Otawara-shi (JP)

(21) Appl. No.: 18/531,853

(22) Filed: Dec. 7, 2023

(30) Foreign Application Priority Data
Dec. 8, 2022 (JP) 2022-196479

(51) Int. Cl. G01N 35/02; G01N 35/00; G01N 35/10

(52) U.S. Cl. CPC G01N 35/026; G01N 35/00663; G01N 35/00732; G01N 35/1002; G01N 35/1009; G01N 2035/00673; G01N 2035/1025

(57) ABSTRACT

A transport rack according to the present embodiment comprises a holder configured to hold a storage container that stores a sample or a reagent that is reacted with the sample, a first observation window configured to enable reading of identification information on the storage container, and a second observation window configured to enable observation of the sample or the reagent stored in the storage container.

### CROSS REFERENCE TO RELATED APPLICATIONS

This application is based upon and claims the benefit of priority from the prior Japanese Patent Application No. 2022-196479, filed on Dec. 8, 2022, the entire contents of which are incorporated herein by reference.

### FIELD

Embodiments described in the present specification and drawings relate generally to a transport rack, an automatic analyzing apparatus, and an automatic analyzing system.

### BACKGROUND

An automatic analyzing apparatus is an apparatus that analyzes a component of a test sample corresponding to each test item by, for example, optically measuring a mixed liquid obtained by mixing a sample such as a test sample collected from a subject such as blood or a standard sample of each test item with a reagent corresponding to each test item.

In the related art, in the automatic analyzing apparatus, liquid level detection of a sample is performed at the time of sampling. In the liquid level detection of the sample, it is determined whether or not a tip of a dispensing probe comes into contact with a liquid level by detecting a change in electrostatic capacitance of the dispensing probe. However, in a method for detecting the liquid level by the change in electrostatic capacitance, the automatic analyzing apparatus may erroneously detect, as the liquid level, an air bubble generated on a sample surface. Then, in a case where the air bubble is erroneously detected as the liquid level, since the automatic analyzing apparatus performs sampling at a position where the air bubble is detected, the sample is not sucked and the sample cannot be dispensed normally. In addition, in the method for detecting the liquid level by the change in electrostatic capacitance, in a case where a storage container that stores the sample is empty or in a case where the amount of sample necessary for a test is not stored in the storage container, an error may occur at a sampling stage, and one step may be wasted. Thus, it is desired to enable observation of the liquid level of the sample before sampling in the automatic analyzing apparatus.

However, although a slit for reading identification information on the storage container is provided in a transport rack of the related art that transports the storage container, a slit or an opening is not provided in a surface opposite to the surface in which the slit is provided. Thus, in a case where the liquid level is observed from the slit for reading the identification information on the storage container, the liquid level of the sample stored in the storage container is hidden by the identification information on the storage container, and the automatic analyzing apparatus cannot observe the liquid level. In order to solve this problem, there is also a technique of rotating the storage container stored in the transport rack. However, in a case where the identification information is read and the liquid level of the sample is observed by using this technique, since it is necessary to rotate the storage container to observe the liquid level of the sample after reading the identification information, an operation becomes complicated and a time is required. In addition, these problems similarly occur not only in the sample stored in the storage container transported by the transport rack but also in the reagent stored in the storage container transported by the transport rack. Thus, in the automatic analyzing apparatus, it is desired, before sampling, to read the identification information and to enable observation of the liquid level of the sample or the liquid level of the reagent.

### BRIEF DESCRIPTION OF THE DRAWINGS

FIG. 1 is a block diagram illustrating an example of a functional configuration of an automatic analyzing apparatus according to a first embodiment;

FIG. 2 is a schematic diagram illustrating a configuration of an analysis mechanism according to the first embodiment;

FIG. 3 is a front view of a transport rack used in the analysis mechanism illustrated in FIG. 2 in the first embodiment;

FIG. 4 is a plan view of a transport rack used in the analysis mechanism illustrated in FIG. 2 in the first embodiment;

FIG. 5 is a conceptual diagram illustrating an example of a configuration of a reading unit in the automatic analyzing apparatus according to the first embodiment;

FIG. 6 is a plan view illustrating an example of a configuration of the reading unit in the automatic analyzing apparatus according to the first embodiment;

FIG. 7 is a conceptual diagram illustrating another example of the configuration of the reading unit in the automatic analyzing apparatus according to the first embodiment;

FIG. 8 is a plan view illustrating another example of the configuration of the reading unit in the automatic analyzing apparatus according to the first embodiment;

FIG. 9 is a flowchart for describing contents of reading processing executed by the automatic analyzing apparatus according to the first embodiment;

FIG. 10 is a flowchart for describing contents of dispensing control processing executed by the automatic analyzing apparatus according to the first embodiment;

FIG. 11 is a front view of a transport rack used in an analysis mechanism illustrated in FIG. 2 in a second embodiment;

FIG. 12 is a plan view of a transport rack used in the analysis mechanism illustrated in FIG. 2 in the second embodiment;

FIG. 13 is a front view of a transport rack used in an analysis mechanism illustrated in FIG. 2 in a third embodiment;

FIG. 14 is a plan view of the transport rack used in the analysis mechanism illustrated in FIG. 2 in the third embodiment;

FIG. 15 is a front view of a transport rack used in an analysis mechanism illustrated in FIG. 2 in a fourth embodiment; and

FIG. 16 is a plan view of the transport rack used in the analysis mechanism illustrated in FIG. 2 in the fourth embodiment.

### DETAILED DESCRIPTION

Hereinafter, respective embodiments of the transport rack, the automatic analyzing apparatus, and the automatic analyzing system will be described with reference to the accompanying drawings. In the embodiments below, the same reference signs are given for identical components in terms of configuration and function, and duplicate description is omitted.

### First Embodiment

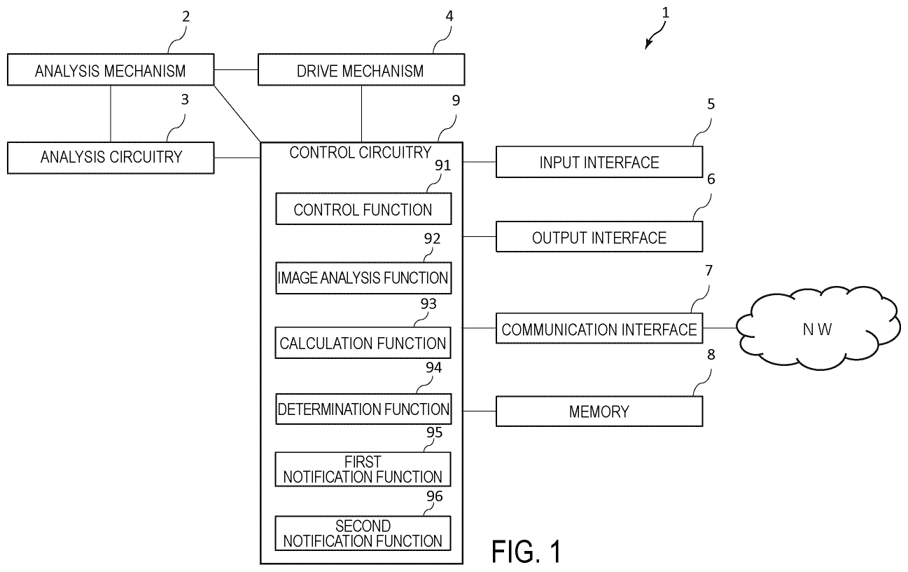

FIG. 1 is a block diagram illustrating an example of a functional configuration of an automatic analyzing apparatus according to a first embodiment. The automatic analyzing apparatus according to the present embodiment is, for example, an apparatus that measures a component in a sample to be measured by measuring a mixed liquid of the sample and a reagent. As illustrated in FIG. 1, an automatic analyzing apparatus 1 according to the present embodiment includes, for example, an analysis mechanism 2, an analysis circuitry 3, a drive mechanism 4, an input interface 5, an output interface 6, a communication interface 7, a memory 8, and a control circuitry 9.

The analysis mechanism 2 adds to the sample a reagent used for each test item set in a sample such as a standard sample or a test sample. The analysis mechanism 2 measures a mixed liquid obtained by adding the reagent to the sample, and generates, for example, standard data and test data. In the present embodiment, the standard data represents measurement data of absorbance for a standard sample whose concentration of a detection target to be included is known. In addition, the test data represents measurement data of absorbance for the test sample. Note that, in the following description, in a case where the standard sample and the test sample are expressed without distinction, these samples may be simply referred to as a “sample”.

The analysis circuitry 3 is a processor that generates calibration data, analysis data, and the like by analyzing the standard data and the test data generated by the analysis mechanism 2. The analysis circuitry 3 reads an analysis program from the memory 8, and generates calibration data, analysis data, and the like according to the read analysis program. For example, the analysis circuitry 3 generates calibration data indicating a relationship between the standard data and a standard value set in advance for the standard sample based on the standard data. In addition, the analysis circuitry 3 generates analysis data represented as a concentration value and an activity value of an enzyme based on test data and calibration data of a test item corresponding to the test data. The analysis circuitry 3 outputs the generated calibration data, analysis data, and the like to the control circuitry 9.

The drive mechanism 4 drives the analysis mechanism 2 under the control of the control circuitry 9. For example, the drive mechanism 4 is realized by a gear, a stepping motor, a belt conveyor, a lead screw, and the like.

The input interface 5 receives setting of an analysis parameter or the like of each test item related to a sample requested to be measured from a user or via an in-hospital network NW, for example. The input interface 5 is realized by, for example, a mouse, a keyboard, a touch pad to which an instruction is input by touching an operation surface, and the like. The input interface 5 is connected to the control circuitry 9, converts an operation instruction input from the user into an electric signal, and outputs the electric signal to the control circuitry 9. Note that, in the present embodiment, the input interface 5 is not limited to the interface including physical operation components such as a mouse and a keyboard. For example, an electric signal processing circuitry that receives an electric signal corresponding to an operation instruction input from an external input device provided separately from the automatic analyzing apparatus 1 and outputs the electric signal to the control circuitry 9 is also included in the example of the input interface 5.

The output interface 6 is connected to the control circuitry 9 and outputs a signal supplied from the control circuitry 9. The output interface 6 is realized by, for example, a display circuitry, a print circuitry, an audio device, and the like. Examples of the display circuitry include a CRT display, a liquid crystal display, an organic EL display, an LED display, and a plasma display. Note that, the display circuitry also includes a processing circuitry that converts data representing a display target into a video signal and outputs the video signal to the outside. The print circuitry includes, for example, a printer. Note that, an output circuitry that outputs data representing a printing target to an outside is also included in the print circuitry. The audio device includes, for example, a speaker. Note that, an output circuitry that outputs an audio signal to the outside is also included in the audio device.

The communication interface 7 is connected to, for example, the in-hospital network NW, and connects the automatic analyzing apparatus 1 to the in-hospital network NW. The communication interface 7 performs data communication with a hospital information system (HIS) via the in-hospital network NW. Note that, the communication interface 7 may perform data communication with the HIS via a laboratory information system (LIS) connected to the in-hospital network NW.

The memory 8 includes a magnetic or optical recording medium, a recording medium readable by a processor, such as a semiconductor memory, or the like. Note that, the memory 8 is not necessarily realized by a single memory device. For example, the memory 8 can be realized by a plurality of memory devices.

In addition, the memory 8 stores an analysis program executed by the analysis circuitry 3 and a control program executed by the control circuitry 9. The memory 8 stores the analysis data generated by the analysis circuitry 3 for each test item. The memory 8 stores test information input from an operator or test information received by the communication interface 7 via the in-hospital network NW. The test information includes information such as a sample ID, a test item required for a sample to be measured, a measurement order related to the test, and the amount of dispensed sample or reagent necessary for the test. Note that, although the test information according to the present embodiment includes the information such as the sample ID, the test item required for the sample to be measured, the measurement order related to the test, and the amount of dispensed sample or reagent necessary for the test, the test information is not limited to these pieces of information. That is, the information included in the test information is any information. The sample ID is an example of identification information in the present embodiment.

In addition, the memory 8 stores observation result information which is an observation result of the sample or the reagent stored in a storage container held by a transport rack to be described later. The observation result information includes, for example, liquid level positional information regarding a liquid level position of the sample or a liquid level position of the reagent stored in the storage container, color information regarding color of the sample or color of the reagent stored in the storage container, liquid level state information regarding a liquid level state of the sample or a liquid level state of the reagent stored in the storage container, and shape information regarding a shape such as a diameter of the storage container. Note that, although the observation result information according to the present embodiment includes the liquid level positional information, the color information, and the liquid level state information, the observation result information is not limited to these pieces of information. That is, the information included in the observation result information is any information.

Further, the memory 8 stores storage amount information regarding the amount of sample or the amount of reagent stored in the storage container. The storage amount information is calculated based on the liquid level positional information, the shape information, and the like in the observation result information.

The control circuitry 9 is a processor that functions as a center of the automatic analyzing apparatus 1. The control circuitry 9 is an example of a processing circuitry. The control circuitry 9 realizes a function corresponding to the operation program by executing the operation program stored in the memory 8. Note that, the control circuitry 9 may include a memory area that stores at least part of the data stored in the memory 8.

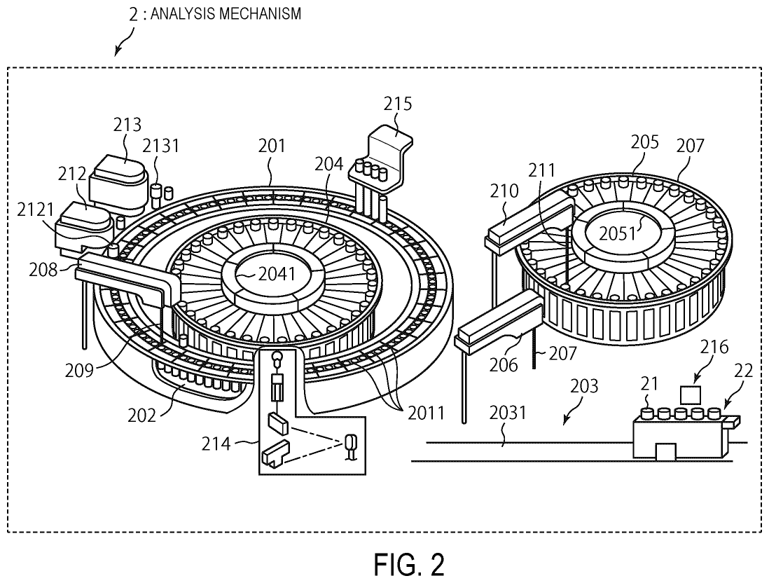

FIG. 2 is a schematic diagram illustrating a configuration of the analysis mechanism 2 according to the first embodiment. As illustrated in FIG. 2, the analysis mechanism 2 according to the present embodiment includes, for example, a reaction disk 201, a thermostatic unit 202, a rack sampler 203, a first reagent storage 204, a second reagent storage 205, a sample dispensing arm 206, a sample dispensing probe 207, a first reagent dispensing arm 208, a first reagent dispensing probe 209, a second reagent dispensing arm 210, a second reagent dispensing probe 211, a first stirring unit 212, a second stirring unit 213, a photometric unit 214, a cleaning unit 215, and a reading unit 216.

The reaction disk 201 holds a plurality of reaction containers 2011 arrayed in a ring shape. The reaction disk 201 transports the plurality of reaction containers 2011 along a predetermined path. Specifically, during an analysis operation of the mixed liquid of the sample and the reagent, the reaction disk 201 is alternately rotated and stopped at predetermined time intervals by the drive mechanism 4. The reaction container 2011 is made of, for example, glass, polypropylene (PP), or acrylic.

The thermostatic unit 202 stores a heating medium set at a predetermined temperature. The thermostatic unit 202 raises a temperature of the mixed liquid stored in the reaction container 2011 to a predetermined temperature and maintains the mixed liquid to be warm by immersing the reaction container 2011 in the stored heat medium.

The rack sampler 203 supports the transport rack 22 capable of holding storage containers 21 in a transportable manner. The storage container 21 stores a sample such as blood requested to be measured, a reagent to react with the sample, or the like. A label is attached to the storage container 21. An optical mark representing identification information of the sample or the reagent stored in the storage container 21 is printed on the label. For example, any pixel code such as a one-dimensional pixel code and a two-dimensional pixel code is used as the optical mark.

Note that, in the example illustrated in FIG. 2, the transport rack 22 capable of holding five storage containers 21 in parallel is illustrated. Note that, the number of storage containers 21 held by the transport rack 22 is not limited to five. That is, the number of storage containers 21 held by the transport rack 22 is any number, and the transport rack 22 may hold four or less storage containers 21 or may hold six or more storage containers 21.

A transport area 2031 for transporting the transport rack 22 is provided in the rack sampler 203. That is, the transport rack 22 is transported from the feeding position where the transport rack 22 is fed to the collecting position where the transport rack 22 whose measurement is completed is collected by using the transport area 2031.

In the present embodiment, in the transport area 2031, the transport rack 22 fed from the feeding position is transported to a dispensing standby position before being transported to a dispensing position by the drive mechanism 4, for example. The dispensing position is a position where suction of the sample or suction of the reagent is performed. The dispensing standby position is a position where the storage container 21 is on standby for dispensing of the sample or dispensing of the reagent, and is provided, for example, on a movement trajectory of the storage container 21 held by the transport rack 22 supported by the rack sampler 203. In addition, in the transport area 2031, in a case where the suction of the sample or the suction of the reagent is performed, the transport rack 22 at the dispensing standby position is transported to the dispensing position by the drive mechanism 4. This dispensing position is provided, for example, at a position where a rotation trajectory of the sample dispensing probe 207 and a movement trajectory of an opening of the storage container 21 supported by the rack sampler 203 and held by the transport rack 22 intersect. Then, in the transport area 2031, after the sample or the reagent stored in the storage container 21 is dispensed, the transport rack 22 at the dispensing position is transported to a collecting position by the drive mechanism 4.

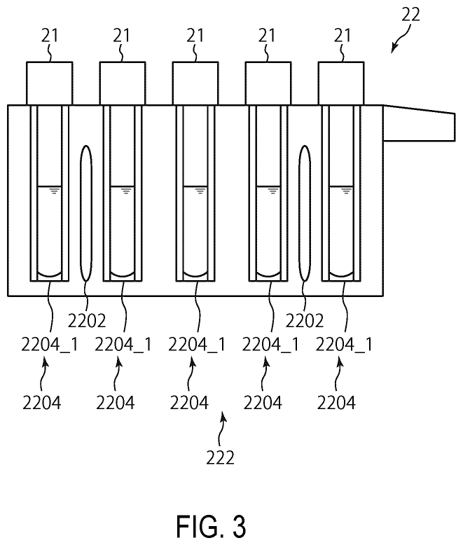

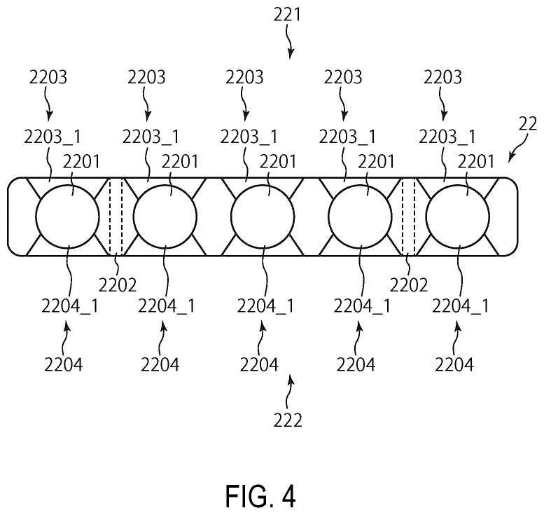

A configuration of the transport rack 22 used in the analysis mechanism 2 in the present embodiment will be described in detail with reference to FIGS. 3 and 4. FIG. 3 is a front view of the transport rack 22 used in the analysis mechanism 2 illustrated in FIG. 2 in the present embodiment, and FIG. 4 is a plan view of the transport rack 22 used in the analysis mechanism 2 illustrated in FIG. 2 in the present embodiment. As illustrated in FIGS. 3 and 4, the transport rack 22 according to the present embodiment includes holders 2201, transport arm connection units 2202, first observation windows 2203, and second observation windows 2204. Note that, in FIG. 3, although the holder 2201 includes the storage container 21, in FIG. 4, the storage container 21 is omitted for the sake of convenience in description.

The holder 2201 holds the storage container 21 in which the sample or the reagent is stored. As illustrated in FIG. 4, the holder 2201 according to the present embodiment is formed in a circular shape in plan view. Note that, a shape of the holder 2201 is any shape, and may be, for example, a polygonal shape in plan view.

The transport arm connection unit 2202 is connected to a transport arm (not illustrated) provided in the analysis mechanism 2 in order to transport the transport rack 22 to a predetermined position. As illustrated in FIGS. 3 and 4, the transport arm connection unit 2202 according to the present embodiment has an elliptic shape in front view, and is formed by a through-hole penetrating from a second side surface 222 of the transport rack 22 in which the second observation window 2204 is provided toward a first side surface 221 of the transport rack 22 on which the first observation window 2203 is provided. Note that, although the transport arm connection unit 2202 according to the present embodiment is formed in the elliptic shape in front view, the shape of the transport arm connection unit 2202 is not limited to the elliptic shape. That is, the shape of the transport arm connection unit 2202 is any shape, and may be a circular shape or a polygonal shape. In addition, the transport arm connection unit 2202 is not limited to the through-hole, and may be a groove or the like.

The first observation window 2203 is an observation window that enables reading of identification information present in the storage container 21 held by the holder 2201. As illustrated in FIGS. 3 and 4, the first observation window 2203 according to the present embodiment is configured by providing a rectangular first slit 2203_1 formed in the first side surface 221 of the transport rack 22. The first slit 2203_1 is formed from the holder 2201 toward the first side surface 221 of the transport rack 22. In addition, as illustrated in FIGS. 3 and 4, the first slit 2203_1 of the first observation window 2203 according to the present embodiment has a tapered shape expanding from the holder 2201 toward the first side surface 221 of the transport rack 22. Note that, although the shape of the first slit 2203_1 of the first observation window 2203 according to the present embodiment is rectangular, the shape of the first slit 2203_1 of the first observation window 2203 is not limited to the rectangular shape. That is, the shape of the first slit 2203_1 is any shape.

The second observation window 2204 is an observation window that enables observation of the sample or the reagent stored in the storage container 21 held by the holder 2201. As illustrated in FIGS. 3 and 4, the second observation window 2204 according to the present embodiment is formed by providing a rectangular second slit 2204_1 formed in the second side surface 222 opposite to the first side surface 221 of the transport rack 22. The second slit 2204_1 is formed from the holder 2201 toward the second side surface 222 of the transport rack 22. In addition, as illustrated in FIGS. 3 and 4, the second slit 2204_1 of the second observation window 2204 according to the present embodiment has a tapered shape expanding from the holder 2201 toward the second side surface 222 of the transport rack 22. Note that, although the shape of the second slit 2204_1 of the second observation window 2204 according to the present embodiment is rectangular, the shape of the second slit 2204_1 of the second observation window 2204 is not limited to the rectangular shape. That is, the shape of the second slit 2204_1 is any shape.

In addition, as illustrated in FIGS. 3 and 4, the first observation window 2203 and the second observation window 2204 according to the present embodiment may be provided such that 50% or more of an outer periphery of the storage container 21 can be observed. The first observation window 2203 and the second observation window 2204 are formed in this manner, and thus, even though the identification information on the storage container 21 is oriented in any direction, the reading unit 216 can read the identification information from the first observation window 2203 or the second observation window 2204. It is possible to reduce labor such as correction of the orientation of the storage container 21.

Note that, although the first slit 2203_1 of the first observation window 2203 and the second slit 2204_1 of the second observation window 2204 according to the present embodiment each have the tapered shape, these slits may not necessarily have the tapered shape. That is, the first slit 2203_1 and the second slit 2204_1 may each have a linear shape from the holder 2201 toward each side surface of the transport rack 22, and at least one of the first slit 2203_1 and the second slit 2204_1 may have the tapered shape.

The transport rack 22 and the automatic analyzing apparatus 1 that analyzes the sample by measuring a component in the sample by using the sample or the reagent stored in the storage container 21 held by the transport rack 22 constitute an automatic analysis system according to the present embodiment.

The first reagent storage 204 cools a plurality of reagent containers storing a first reagent that reacts with a predetermined component contained in the standard sample and the test sample. The first reagent is, for example, a buffer solution containing bovine serum albumin (BSA) or the like. A reagent label is attached to the reagent container. An optical mark representing reagent information is printed on the reagent label. For example, any pixel code such as a one-dimensional pixel code and a two-dimensional pixel code is used as the optical mark. The reagent information is information regarding the reagent contained in the reagent container, and includes, for example, a reagent name, a reagent manufacturer code, a reagent item code, a bottle type, a bottle size, a volume, a production lot number, a valid period, and the like.

In addition, the first reagent storage 204 keeps cool a plurality of standard sample containers storing standard samples. Each of the plurality of standard sample containers contains a standard sample of the same component having different concentrations. Note that, the standard sample containers may be held by the transport rack 22.

A reagent rack 2041 is rotatably provided in the first reagent storage 204. The reagent rack 2041 holds a plurality of reagent containers and a plurality of standard sample containers arrayed in an annular shape. The reagent rack 2041 is rotated by the drive mechanism 4. In addition, a reader (not illustrated) that reads reagent information from a reagent label attached to the reagent container is provided in the first reagent storage 204. The read reagent information is stored in the memory 8.

A first reagent suction position is set at a predetermined position on the first reagent storage 204. The first reagent suction position is provided, for example, at a position where a rotation trajectory of the first reagent dispensing probe 209 and a movement trajectory of openings of the reagent container and the standard sample container annularly arrayed in the reagent rack 2041 intersect.

The second reagent storage 205 keeps cool a plurality of reagent containers storing a second reagent paired with the first reagent of two reagent systems. The second reagent is a solution containing an insoluble carrier, for example, a carrier particle, on which a predetermined antigen or antibody contained in the sample and an antigen or antibody bound or separated by a specific antigen-antibody reaction are immobilized. An enzyme, a substrate, an aptamer, or a receptor may be bound or separated by a specific reaction. In the second reagent storage 205, a reagent rack 2051 is rotatably provided.

The reagent rack 2051 holds a plurality of reagent containers arrayed in an annular shape. Note that, the standard sample container storing the standard sample may be kept cool in the second reagent storage 205. The reagent rack 2051 is rotated by the drive mechanism 4. In addition, in the second reagent storage 205, a reader (not illustrated) that reads reagent information from a reagent label attached to the reagent container is provided. The read reagent information is stored in the memory 8.

A second reagent suction position is set at a predetermined position on the second reagent storage 205. The second reagent suction position is provided, for example, at a position where a rotation trajectory of the second reagent dispensing probe 211 and a movement trajectory of openings of the reagent containers annularly arrayed in the reagent rack 2051 intersect.

The sample dispensing arm 206 is provided between the reaction disk 201 and the rack sampler 203. The sample dispensing arm 206 is provided to be movable up and down in a vertical direction and to be rotatable in a horizontal direction by the drive mechanism 4. The sample dispensing arm 206 holds the sample dispensing probe 207 at one end.

The sample dispensing probe 207 rotates along an arc-shaped rotation trajectory along with the rotation of the sample dispensing arm 206. A dispensing position is provided on the movement trajectory. In addition, a sample discharge position for discharging the sample sucked by the sample dispensing probe 207 to the reaction container 2011 is provided on the rotation trajectory of the sample dispensing probe 207. The sample discharge position is provided at a position where the rotation trajectory of the sample dispensing probe 207 and a movement trajectory of the reaction container 2011 held by the reaction disk 201 intersect.

The sample dispensing probe 207 is driven by the drive mechanism 4 and moves in an up and down direction at the dispensing position or the sample discharge position. In addition, the sample dispensing probe 207 sucks the sample from the storage container 21 at the dispensing position under the control of the control circuitry 9. In addition, the sample dispensing probe 207 discharges the sucked sample to the reaction container 2011 positioned immediately below the sample discharge position under the control of the control circuitry 9.

In addition, in the present embodiment, in a case where the reagent is stored in the storage container 21 held by the transport rack 22, the sample dispensing probe 207 sucks the reagent stored in the storage container 21 and discharges the reagent to the reaction container 2011. Specifically, the sample dispensing probe 207 sucks the reagent from the storage container 21 positioned immediately below at the dispensing position under the control of the control circuitry 9. In addition, the sample dispensing probe 207 discharges the sucked reagent to the reaction container 2011 positioned immediately below the sample discharge position under the control of the control circuitry 9. The sample dispensing probe 207 is a dispensing probe in the present embodiment.

The first reagent dispensing arm 208 is provided in the vicinity of an outer periphery of the first reagent storage 204. The first reagent dispensing arm 208 is provided to be movable up and down in the vertical direction and to be rotatable in the horizontal direction by the drive mechanism 4. The first reagent dispensing arm 208 holds the first reagent dispensing probe 209 at one end.

The first reagent dispensing probe 209 rotates along an arc-shaped rotation trajectory along with the rotation of the first reagent dispensing arm 208. The first reagent suction position is provided on the rotation trajectory. In addition, a first reagent discharge position for discharging the first reagent or the standard sample sucked by the first reagent dispensing probe 209 to the reaction container 2011 is set on the rotation trajectory of the first reagent dispensing probe 209. The first reagent discharge position is provided at a position where the movement trajectory of the first reagent dispensing probe 209 and the movement trajectory of the reaction container 2011 held by the reaction disk 201 intersect.

The first reagent dispensing probe 209 is driven by the drive mechanism 4 and moves in the up and down direction at the first reagent suction position or the first reagent discharge position on the rotation trajectory. In addition, the first reagent dispensing probe 209 sucks the first reagent or the standard sample from the reagent container positioned immediately below the first reagent suction position under the control of the control circuitry 9. In addition, the first reagent dispensing probe 209 discharges the sucked first reagent or standard sample to the reaction container 2011 positioned immediately below the first reagent discharge position under the control of the control circuitry 9.

The second reagent dispensing arm 210 is provided in the vicinity of the outer periphery of the first reagent storage 204. The second reagent dispensing arm 210 is provided to be movable up and down in the vertical direction and to be rotatable in the horizontal direction by the drive mechanism 4. The second reagent dispensing arm 210 holds the second reagent dispensing probe 211 at one end.

The second reagent dispensing probe 211 rotates along an arc-shaped rotation trajectory along with the rotation of the second reagent dispensing arm 210. The second reagent suction position is provided on the rotation trajectory. In addition, a second reagent discharge position for discharging the second reagent sucked by the second reagent dispensing probe 211 to the reaction container 2011 is set on the rotation trajectory of the second reagent dispensing probe 211. The second reagent discharge position is provided at a position where the movement trajectory of the second reagent dispensing probe 211 and the movement trajectory of the reaction container 2011 held by the reaction disk 201 intersect.

The second reagent dispensing probe 211 is driven by the drive mechanism 4 and moves in the up and down direction at the second reagent suction position or the second reagent discharge position on the rotation trajectory. In addition, the second reagent dispensing probe 211 sucks the second reagent from the reagent container positioned immediately below the second reagent suction position under the control of the control circuitry 9. In addition, the second reagent dispensing probe 211 discharges the sucked second reagent to the reaction container 2011 positioned immediately below the second reagent discharge position under the control of the control circuitry 9. As can be seen from this, the second reagent dispensing arm 210 and the second reagent dispensing probe 211 constitute a second reagent dispensing device according to the present embodiment.

The first stirring unit 212 is provided in the vicinity of an outer periphery of the reaction disk 201. The first stirring unit 212 includes a first stirring arm 2121 and also includes a first stirring bar provided at a tip of the first stirring arm 2121. The first stirring unit 212 stirs, by the first stirring bar, the mixed liquid of the standard sample and the first reagent stored in the reaction container 2011 positioned at a first stirring position on the reaction disk 201. In addition, the first stirring unit 212 stirs, by the first stirring bar, the mixed liquid of the test sample and the first reagent stored in the reaction container 2011 positioned at the first stirring position on the reaction disk 201.

The second stirring unit 213 is provided in the vicinity of the outer periphery of the reaction disk 201. The second stirring unit 213 includes a second stirring arm 2131 and also includes a second stirring bar provided at a tip of the second stirring arm 2131. The second stirring unit 213 stirs, by the second stirring bar, the mixed liquid of the standard sample, the first reagent, and the second reagent stored in the reaction container 2011 positioned at a second stirring position on the reaction disk 201. In addition, the second stirring unit 213 stirs, by the second stirring bar, the mixed liquid of the test sample, the first reagent, and the second reagent stored in the reaction container 2011 positioned at the second stirring position.

The photometric unit 214 optically measures a reaction liquid of the sample, the first reagent, and the second reagent discharged into the reaction container 2011. The photometric unit 214 includes a light source and a photodetector. The photometric unit 214 emits light from the light source under the control of the control circuitry 9. The emitted light is incident from a first sidewall of the reaction container 2011 and is emitted from a second sidewall facing the first side wall. The photometric unit 214 detects the light emitted from the reaction container 2011 by the photodetector.

Specifically, for example, the photodetector is disposed at a position on an optical axis of the light emitted from the light source to the reaction container 2011. The photodetector detects light transmitted through a reaction liquid of the standard sample, the first reagent, and the second reagent in the reaction container 2011, and generates standard data represented by absorbance based on intensity of the detected light. In addition, the photodetector detects light transmitted through a reaction liquid of the test sample, the first reagent, and the second reagent in the reaction container 2011, and generates test data represented by absorbance based on intensity of the detected light. The photometric unit 214 outputs, as a measurement result, the generated standard data and test data to the analysis circuitry 3.

The cleaning unit 215 cleans the inside of the reaction container 2011 in which the measurement of the reaction liquid is ended by the photometric unit 214.

The reading unit 216 reads the identification information via the first observation window 2203 that enables reading of the identification information on the storage container 21 held by the transport rack 22 that transports the storage container 21 that stores the sample or the reagent, and reads the observation result information that is the observation result of the sample or the reagent stored in the storage container 21 held by the transport rack 22 via the second observation window 2204 that enables observation of the sample or the reagent stored in the storage container 21. The reading unit 216 corresponds to an information reader in the present embodiment.

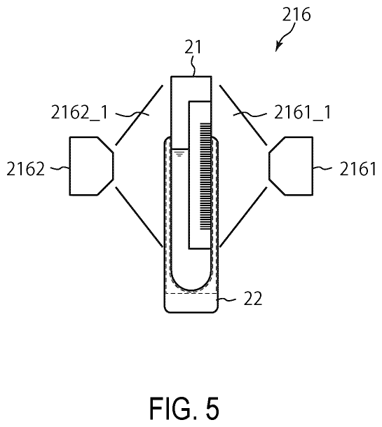

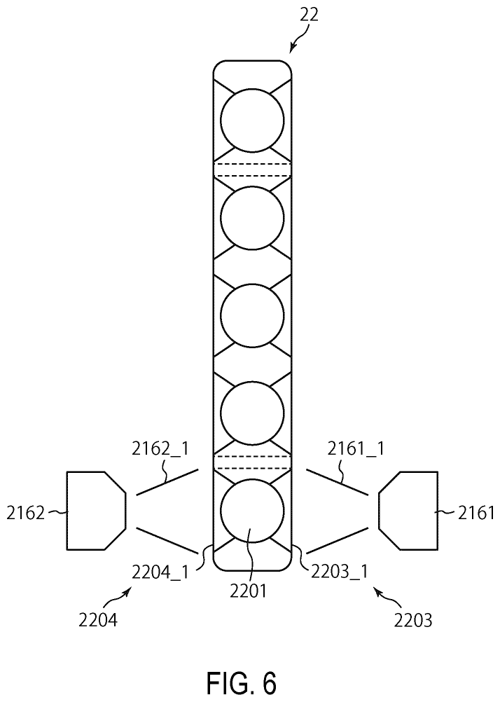

A configuration of the reading unit 216 according to the present embodiment will be described in detail with reference to FIGS. 5 and 6. FIG. 5 is a conceptual diagram illustrating an example of the configuration of the reading unit 216 in the automatic analyzing apparatus 1 according to the present embodiment. FIG. 6 is a plan view illustrating an example of the configuration of the reading unit according to the present embodiment. As illustrated in FIGS. 5 and 6, the reading unit 216 according to the present embodiment includes a first imaging device 2161 and a second imaging device 2162.

The first imaging device 2161 reads the identification information on the storage container 21 by reading the optical mark on the storage container 21 via the first slit 2203_1 of the first observation window 2203. As illustrated in FIG. 5, in order to read the identification information on the storage container 21, the first imaging device 2161 is provided such that a range from an upper end of the storage container 21 to a lower end of the first slit 2203_1 is included in a first imaging range 2161_1 which is an imaging range of the first imaging device 2161. In addition, as illustrated in FIG. 6, in order to read the identification information on the storage container 21, the first imaging device 2161 is provided such that a range from one end of the first slit 2203_1 to the other end of the first slit 2203_1 is included in the first imaging range 2161_1. The first imaging device 2161 corresponds to a first reader in the present embodiment.

In addition, the second imaging device 2162 reads observation result information that is an observation result of the sample or the reagent stored in the storage container 21 via the second slit 2204_1 of the second observation window 2204. As illustrated in FIG. 5, in order to read the observation result information of the sample or the reagent such as the liquid level of the sample or the liquid level of the reagent stored in the storage container 21 and the color of the sample or the color of the reagent, the second imaging device 2162 is provided such that the range from the upper end of the storage container 21 to a lower end of the second slit 2204_1 is included in a second imaging range 2162_1 that is an imaging range of the second imaging device 2162. In addition, as illustrated in FIG. 6, in order to read the observation result information of the sample or the reagent in the storage container 21, the second imaging device 2162 is provided such that a range from one end of the second slit 2204_1 to the other end of the second slit 2204_1 is included in the second imaging range 2162_1. The second imaging device 2162 corresponds to a second reader in the present embodiment.

Note that, although the reading unit 216 illustrated in FIGS. 5 and 6 is configured by providing one imaging device for each of the first observation window 2203 and the second observation window 2204, the reading unit 216 illustrated in FIGS. 5 and 6 is not limited to a case where one imaging device is provided for each of the first observation window 2203 and the second observation window 2204. That is, the number of imaging devices provided for the first observation window 2203 and the second observation window 2204 is any number, and for example, the reading unit 216 may provide a plurality of imaging devices for each of the first observation window 2203 and the second observation window 2204.

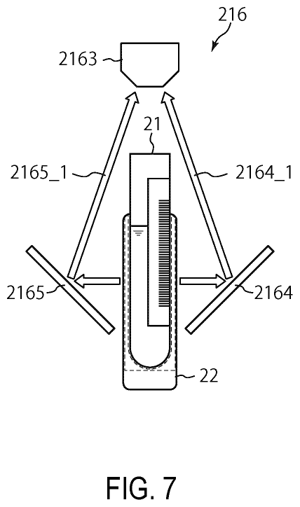

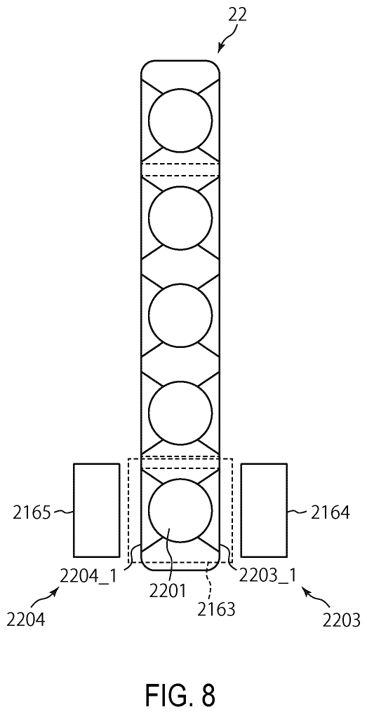

In addition, in the automatic analyzing apparatus 1 according to the present embodiment described above, although the reading unit 216 is configured by providing the imaging device for each of the first observation window 2203 and the second observation window 2204, the imaging device may not be necessarily provided for each of the first observation window 2203 and the second observation window 2204. That is, the reading unit 216 may be configured by providing one imaging device. FIG. 7 is a conceptual diagram illustrating another example of the configuration of the reading unit 216 in the automatic analyzing apparatus 1 according to the present embodiment, and is a diagram corresponding to FIG. 5. FIG. 8 is a plan view illustrating another example of the configuration of the reading unit 216 in the automatic analyzing apparatus 1 according to the present embodiment, and is a diagram corresponding to FIG. 6. Hereinafter, portions different from FIGS. 5 and 6 described above will be described.

As illustrated in FIGS. 7 and 8, reading unit 216 includes an imaging device 2163, a first mirror 2164, and a second mirror 2165.

The imaging device 2163 reads the identification information via the first slit 2203_1 of the first observation window 2203 and reads the observation result information via the second slit 2204_1 of the second observation window 2204. In the example illustrated in FIGS. 7 and 8, the imaging device 2163 is provided so as to face an upper surface of the transport rack 22. The imaging device 2163 corresponds to a reader in the present embodiment.

In order for the imaging device 2163 to read the identification information via the first slit 2203_1 of the first observation window 2203, the first mirror 2164 is provided at a position facing the first slit 2203_1 of the first observation window 2203. In addition, the first mirror 2164 forms a first optical path 2164_1 between the first slit 2203_1 of the first observation window 2203 and the imaging device 2163. In the example illustrated in FIGS. 7 and 8, in order to form the first optical path 2164_1 between the first slit 2203_1 of the first observation window 2203 and the imaging device 2163, the first mirror 2164 is provided at an angle inclined by 45° with respect to a horizontal plane.

In order for the imaging device 2163 to read the observation result information via the second slit 2204_1 of the second observation window 2204, the second mirror 2165 is provided at a position facing the second slit 2204_1 of the second observation window 2204, and forms a second optical path 2165_1 between the second slit 2204_1 of the second observation window 2204 and the imaging device 2163. In the example illustrated in FIGS. 7 and 8, in order to form the second optical path 2165_1 between the second slit 2204_1 of the second observation window 2204 and the imaging device 2163, the second mirror 2165 is provided at an angle inclined by 45° with respect to the horizontal plane.

Note that, although the first mirror 2164 and the second mirror 2165 are provided at an angle inclined by 45° with respect to the horizontal plane, the angle at which the first mirror 2164 and the second mirror 2165 are provided is not limited thereto. That is, the angle at which the first mirror 2164 and the second mirror 2165 are provided is any angle according to the position of the imaging device 2163.

As illustrated in FIGS. 5 and 6, the reading unit 216 may provide an imaging device for each of the first observation window 2203 and the second observation window 2204, and as illustrated in FIGS. 7 and 8, the reading unit 216 may provide one imaging device for the first observation window 2203 and the second observation window 2204. In the following description, as illustrated in FIGS. 5 and 6, the details of the present embodiment will be described by taking, as an example, a case where the imaging device is provided for each of the first observation window 2203 and the second observation window 2204.

In the control circuitry 9 illustrated in FIG. 1, for example, the control circuitry 9 executes a control program to realize a control function 91, an image analysis function 92, a calculation function 93, a determination function 94, a first notification function 95, and a second notification function 96. Note that, in the present embodiment, although a case where the control function 91, the image analysis function 92, the calculation function 93, the determination function 94, the first notification function 95, and the second notification function 96 are realized by a single processor will be described, the present invention is not limited thereto. For example, a control circuitry may be configured by combining a plurality of independent processors, and each processor may execute a control program to realize the control function 91, the image analysis function 92, the calculation function 93, the determination function 94, the first notification function 95, and the second notification function 96.

The control function 91 is a function of integrally controlling the units in the automatic analyzing apparatus 1 based on input information input from the input interface 5. For example, the control function 91 controls the drive mechanism 4 and the analysis mechanism 2 in the control circuitry 9, and controls the analysis circuitry 3 so as to perform analysis corresponding to the test item. Specifically, the control function 91 controls the sample dispensing probe 207 based on the identification information and the observation result information read by the reading unit 216.

The image analysis function 92 analyzes image data to generate various kinds of information. For example, the image analysis function 92 is a function of analyzing the image data generated by the reading unit 216 in the control circuitry 9 to generate the observation result information and the identification information.

The calculation function 93 is a function of calculating the storage amount information regarding the amount of sample or the amount of reagent stored in the storage container 21 based on the observation result information read by the reading unit 216. For example, the calculation function 93 calculates the storage amount information regarding the amount of sample or the amount of reagent stored in the storage container 21 based on the shape information and the liquid level positional information included in the observation result information.

The determination function 94 is a function of determining whether or not there is the amount of sample necessary for test in the storage container 21 based on the test information and the storage amount information calculated by the calculation function 93. In addition, the determination function 94 is a function of determining whether or not a state of the sample or a state of the reagent stored in the storage container 21 is in a predetermined state based on the color information included in the observation result information. For example, in a case where the sample is serum or plasma, the state of the sample being in the predetermined state is a state where chyle, jaundice, hemolysis, or the like occurs in the sample, and chyle, jaundice, hemolysis, or the like occurs to such an extent that the sample cannot be measured, or a state where chyle, jaundice, hemolysis, or the like occurs to such an extent that the measurement result is affected, or the like. In addition, the state of the reagent being in the predetermined state is a state where a change in color tone, turbidity, or the like occurs in the reagent and the reagent cannot be used for measurement, or a state where a change in color tone, turbidity, or the like occurs to such an extent that the measurement result is affected, or the like.

In a case where the determination function 94 determines that there is not the amount of sample or the amount of reagent necessary for the test in the storage container 21, the first notification function 95 is a function of notifying that the amount of sample or the amount of reagent is insufficient. For example, the first notification function 95 notifies the user that the amount of sample is insufficient via the output interface 6.

The second notification function 96 is a function of notifying that the liquid level of the sample or the liquid level of the reagent stored in the storage container 21 is not detected. For example, the second notification function 96 notifies the user that the liquid level of the sample or the liquid level of the reagent is not detected via the output interface 6.

Note that, the control function 91, the image analysis function 92, the calculation function 93, the determination function 94, the first notification function 95, and the second notification function 96 illustrated in FIG. 1 constitute a control unit, an image analysis unit, a calculation unit, a determination unit, a first notification unit, and a second notification unit in the present embodiment, respectively.

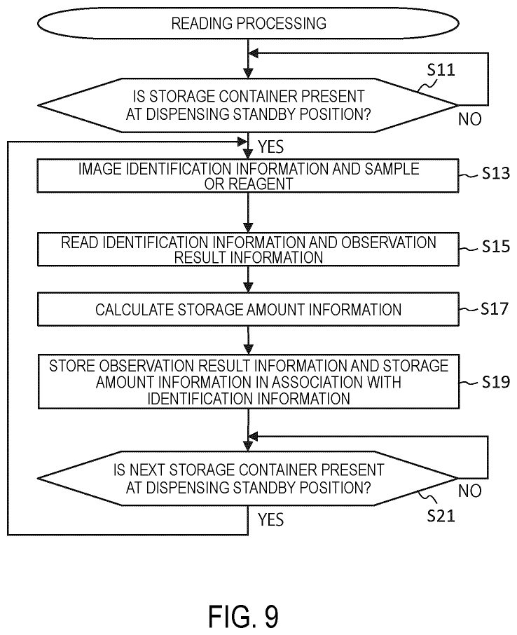

FIG. 9 is a flowchart for describing contents of reading processing executed by the automatic analyzing apparatus 1 according to the present embodiment. In this reading processing, the identification information and the observation result information are read, the amount of stored sample or reagent is calculated, and the read identification information, the observation result information, and the storage amount information are stored. For example, this reading processing is processing executed in a case where the transport rack 22 holding the storage container 21 is fed to the feeding position.

As illustrated in FIG. 9, first, the automatic analyzing apparatus 1 determines whether or not the storage container 21 is present at the dispensing standby position. The processing of determining whether or not the storage container 21 is present at the dispensing standby position is realized by the control function 91 in the control circuitry 9. Then, in a case where the storage container 21 is not present at the dispensing standby position (step S11: No), the automatic analyzing apparatus 1 is on standby until the storage container 21 is transported to the dispensing standby position.

On the other hand, in a case where the storage container 21 is present at the dispensing standby position (step S11: Yes), as illustrated in FIG. 9, the automatic analyzing apparatus 1 images the identification information and the sample or the reagent (step S13). This imaging processing is realized by the control function 91 in the control circuitry 9. Specifically, the automatic analyzing apparatus 1 controls the reading unit 216 to image the optical mark indicating the identification information of the storage container 21 present at the dispensing standby position and the sample or the reagent stored in the storage container 21, and generates image data regarding the optical mark and the sample or the reagent stored in the storage container 21.

Subsequently, as illustrated in FIG. 9, the automatic analyzing apparatus 1 reads the identification information and the observation result information (step S15). The processing of reading the identification information and the observation result information is realized by the image analysis function 92 in the control circuitry 9. Specifically, the automatic analyzing apparatus 1 reads the identification information and the observation result information by performing image analysis on the image data regarding the optical mark and the sample or the reagent stored in the storage container 21, which is generated in step S13. More specifically, the reading unit 216 reads the identification information and the observation result information by causing the image analysis function 92 to perform image analysis on the image data regarding the optical mark and the sample or the reagent stored in the storage container 21, which is generated in step S13.

Subsequently, as illustrated in FIG. 9, the automatic analyzing apparatus 1 calculates the storage amount information (step S17). The processing of calculating the storage amount information is realized by the calculation function 93 in the control circuitry 9. Specifically, the automatic analyzing apparatus 1 calculates the storage amount information regarding the amount of sample or the amount of reagent stored in the storage container 21 based on the shape information and the liquid level positional information included in the observation result information read in step S15.

Subsequently, as illustrated in FIG. 9, the automatic analyzing apparatus 1 stores the observation result information and the storage amount information in association with the identification information (step S19). The processing of storing the observation result information and the storage amount information in association with the identification information is realized by the calculation function 93 in the control circuitry 9. Specifically, the automatic analyzing apparatus 1 stores the observation result information read in step S15 and the storage amount information calculated in step S17 in the memory 8 in association with the identification information read in step S15.

Subsequently, as illustrated in FIG. 9, the automatic analyzing apparatus 1 determines whether or not a next storage container 21 is present at the dispensing standby position (step S21). The processing of determining whether or not the next storage container 21 is present at the dispensing standby position is realized by the control function 91 in the control circuitry 9. Then, in a case where the next storage container 21 is not present at the dispensing standby position (step S21: No), the automatic analyzing apparatus 1 is on standby until the next storage container 21 is transported to the dispensing standby position. On the other hand, in a case where the next storage container 21 is present at the dispensing standby position (step S21: Yes), the automatic analyzing apparatus 1 returns to step S13 and repeats the processing from step S13.

The reading processing illustrated in FIG. 9 is repeatedly executed while the automatic analyzing apparatus 1 is activated, and is ended when the automatic analyzing apparatus 1 is stopped.

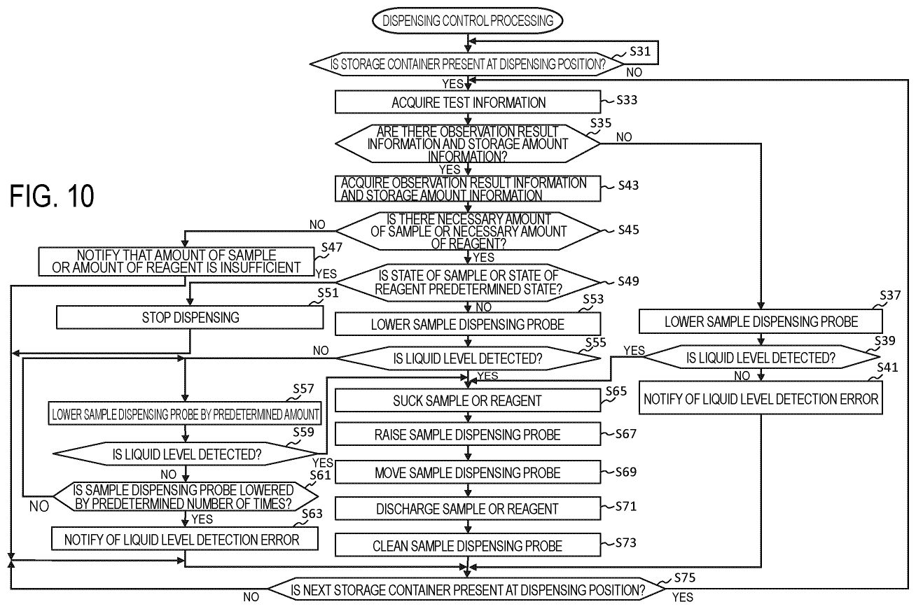

FIG. 10 is a flowchart for describing contents of dispensing control processing executed by the automatic analyzing apparatus 1 according to the present embodiment. In this dispensing control processing, it is determined whether or not there is a necessary amount of sample or amount of reagent, the user is notified in a case where the amount of sample or amount of reagent is insufficient, it is determined whether or not the state of the sample or the state of the reagent is in the predetermined state, dispensing is stopped in a case where the state of the sample or the state of the reagent is in the predetermined state, the sample dispensing probe 207 is lowered, or the sample or the reagent is sucked. For example, this dispensing control processing is processing executed in a case where the storage container 21 is present at the dispensing position.

As illustrated in FIG. 10, first, the automatic analyzing apparatus 1 determines whether or not the storage container 21 is present at the dispensing position (step S31). The processing of determining whether or not the storage container 21 is present at the dispensing position is realized by the control function 91 in the control circuitry 9. Then, in a case where the storage container 21 is not present at the dispensing position (step S31: No), the automatic analyzing apparatus 1 is on standby until the storage container 21 is transported to the dispensing position.

On the other hand, in step S31, in a case where the storage container 21 is present at the dispensing position (step S31: Yes), the automatic analyzing apparatus 1 acquires the test information (step S33). The processing of acquiring the test information is realized by the control function 91 in the control circuitry 9. Specifically, the automatic analyzing apparatus 1 acquires the test information stored in the memory 8 based on the identification information on the storage container 21 read in the reading processing.

Subsequently, as illustrated in FIG. 10, the automatic analyzing apparatus 1 determines whether or not there are the observation result information and the storage amount information (step S35). The processing of determining whether or not there are the observation result information and the storage amount information is realized by the control function 91 in the control circuitry 9. Specifically, the automatic analyzing apparatus 1 determines whether or not the observation result information read in the reading processing and the storage amount information calculated in the reading processing are stored in the memory 8.

Then, in a case where there is not the observation result information and the storage amount information (step S35: No), the sample dispensing probe 207 is lowered (step S37). The processing of lowering the sample dispensing probe 207 is realized by the control function 91 in the control circuitry 9. Specifically, at the dispensing position, the automatic analyzing apparatus 1 lowers the sample dispensing probe 207 to a suction position in the vicinity of the liquid level of the sample or the liquid level of the reagent stored in the storage container 21.

Subsequently, as illustrated in FIG. 10, the automatic analyzing apparatus 1 determines whether or not the liquid level is detected (step S39). The processing of determining whether or not the liquid level is detected is realized by the control function 91 in the control circuitry 9. Specifically, the automatic analyzing apparatus 1 determines whether or not the liquid level is detected by determining whether or not an electrostatic capacitance is changed by a liquid level detection method using the electrostatic capacitance.

Then, in a case where the liquid level is not detected in step S39 (step S39: No), the automatic analyzing apparatus 1 notifies the user of a liquid level detection error (step S41). The processing of notifying the user of the liquid level detection error is realized by the second notification function 96 in the control circuitry 9. Specifically, the automatic analyzing apparatus 1 notifies, as the liquid level detection error, the user that the liquid level is not detected via the output interface 6.

On the other hand, in step S35, in a case where there are the observation result information and the storage amount information (step S35: Yes), the automatic analyzing apparatus 1 acquires the observation result information and the storage amount information (step S43). The processing of acquiring the observation result information and the storage amount information is realized by the control function 91 in the control circuitry 9. Specifically, the automatic analyzing apparatus 1 acquires the observation result information and the storage amount information stored in the memory 8.

Subsequently, as illustrated in FIG. 10, the automatic analyzing apparatus 1 determines whether or not there is the amount of sample or the amount of reagent necessary for the storage container 21 (step S45). The processing of determining whether or not there is the amount of sample or the amount of reagent necessary for the storage container 21 is realized by the control function 91 in the control circuitry 9. Specifically, the automatic analyzing apparatus 1 determines whether or not there is the amount of sample or the amount of reagent necessary for the storage container 21 based on the test information acquired in step S33 and the storage amount information acquired in step S43.

Then, in step S45, in a case where there is not the amount of sample or the amount of reagent necessary for the storage container 21 (step S45: No), the automatic analyzing apparatus 1 notifies the user that the amount of sample or the amount of reagent is insufficient (step S47). The processing of notifying the user that the amount of the sample or the amount of the reagent is insufficient is realized by the first notification function 95 in the control circuitry 9. Specifically, the automatic analyzing apparatus 1 notifies the user that the necessary amount of sample or reagent is insufficient via the output interface 6.

On the other hand, in a case where there is the amount of sample or the amount of reagent necessary for the storage container 21 in step S45 (step S45: Yes), the automatic analyzing apparatus 1 determines whether or not the state of the sample or the state of the reagent stored in the storage container 21 is a predetermined state (step S49). The processing of determining whether or not the state of the sample or the state of the reagent is the predetermined state is realized by the determination function 94 in the control circuitry 9. Specifically, the automatic analyzing apparatus 1 determines a type of the sample or a type of the reagent stored in the storage container 21 based on the color information in the observation result information acquired in step S45, and determines whether or not the state of the sample or the state of the reagent stored in the storage container 21 is the predetermined state.

Note that, although the type of the sample or the type of the reagent stored in the storage container 21 is determined in step S49, in a case where the type of the sample or the type of the reagent stored in the storage container 21 is determined from the test information or the like, in step S49, the automatic analyzing apparatus 1 determines whether or not the state of the sample or the state of the reagent stored in the storage container 21 is the predetermined state based on the test information acquired in step S33 and the color information in the observation result information acquired in step S45.

Then, in step S49, in a case where it is determined that the state of the sample or the state of the reagent is the predetermined state (step S49: Yes), the automatic analyzing apparatus 1 stops the dispensing (step S51). The processing of stopping the dispensing is realized by the control function 91 in the control circuitry 9. Specifically, the automatic analyzing apparatus 1 stops the dispensing of the sample or the reagent stored in the storage container 21 transported to the dispensing position.

On the other hand, in step S49, in a case where it is determined that the state of the sample or the state of the reagent is not the predetermined state (step S49: No), the automatic analyzing apparatus 1 lowers the sample dispensing probe 207 (step S53). The processing of lowering the sample dispensing probe 207 is realized by the control function 91 in the control circuitry 9. Specifically, the automatic analyzing apparatus 1 lowers the sample dispensing probe 207 based on the liquid level positional information in the observation result information acquired in step S43.

Subsequently, as illustrated in FIG. 10, the automatic analyzing apparatus 1 determines whether or not the liquid level is detected (step S55). The processing of determining whether or not the liquid level is detected is realized by the control function 91 in the control circuitry 9. Specifically, the automatic analyzing apparatus 1 determines whether or not the liquid level is detected by determining whether or not an electrostatic capacitance is changed by a liquid level detection method using the electrostatic capacitance.

Then, in step S55, in a case where the liquid level is not detected (step S55: No), the automatic analyzing apparatus 1 lowers the sample dispensing probe 207 by a predetermined amount (step S57). The processing of lowering the sample dispensing probe 207 by the predetermined amount is realized by the control function 91 in the control circuitry 9. Specifically, the automatic analyzing apparatus 1 lowers the sample dispensing probe 207 lowered in step S53 by the predetermined amount toward the liquid level. Here, the predetermined amount is, for example, an amount of 1 mm or the like, but the predetermined amount is not limited thereto. That is, the predetermined amount is any amount, and may be 1 mm or more and 1 mm or less.

Subsequently, as illustrated in FIG. 10, the automatic analyzing apparatus 1 determines whether or not the liquid level is detected (step S59). The processing of determining whether or not the liquid level is detected is realized by the control function 91 in the control circuitry 9. Specifically, the automatic analyzing apparatus 1 determines whether or not the liquid level is detected by determining whether or not an electrostatic capacitance is changed by a liquid level detection method using the electrostatic capacitance.

Note that, in step S39, step S55, and step S59, although the liquid level is detected by a change in electrostatic capacitance as a liquid level detection method, the liquid level detection method is not limited thereto. That is, the liquid level detection method in step S39, step S55, and step S59 is any method, and for example, the liquid level may be detected by a change in pressure, the liquid level may be detected by a change in resistance value, or the liquid level may be detected by using the first imaging device 2161 or the second imaging device 2162.

Then, in step S59, in a case where the liquid level is not detected (step S59: No), the automatic analyzing apparatus 1 determines whether or not the sample dispensing probe 207 is lowered a predetermined number of times (step S61). The processing of determining whether or not the sample dispensing probe 207 is lowered the predetermined number of times is realized by the control function 91 in the control circuitry 9. Then, in step S61, in a case where the number of times the sample dispensing probe 207 is lowered by the predetermined amount is less than a predetermined number of times, that is, in a case where the sample dispensing probe 207 is not lowered by the predetermined number of times (step S61: No), the automatic analyzing apparatus 1 returns to step S57, repeats the processing from step S57 to step S61, and is on standby. That is, the automatic analyzing apparatus 1 lowers the sample dispensing probe 207 by the predetermined amount again by the control function 91.

On the other hand, in a case where the number of times the sample dispensing probe 207 is lowered by the predetermined amount reaches the predetermined number of times in step S61, that is, in a case where the sample dispensing probe 207 is lowered by the predetermined number of times (step S61: Yes), the automatic analyzing apparatus 1 notifies the user of the liquid level detection error (step S63). The processing of notifying the user of the liquid level detection error is realized by the second notification function 96 in the control circuitry 9. Specifically, the automatic analyzing apparatus 1 notifies, as the liquid level detection error, the user that the liquid level is not detected via the output interface 6.

On the other hand, when the liquid level is detected in step S39, step S55, and step S59 (step S39, step S55, step S59: Yes), the automatic analyzing apparatus 1 sucks the sample or the reagent (step S65). The processing of sucking the sample or the reagent is realized by the control function 91 in the control circuitry 9. Specifically, the automatic analyzing apparatus 1 sucks the sample or the reagent stored in the storage container 21 transported to the dispensing position based on the test information acquired in step S33.

Subsequently, as illustrated in FIG. 10, the automatic analyzing apparatus 1 raises the sample dispensing probe 207 (step S67). The processing of raising the sample dispensing probe 207 is realized by the control function 91 in the control circuitry 9. Specifically, the automatic analyzing apparatus 1 raises the sample dispensing probe 207 so as to remove a tip of the sample dispensing probe 207 from the storage container 21.

Subsequently, as illustrated in FIG. 10, the automatic analyzing apparatus 1 moves the sample dispensing probe 207 (step S69). The processing of moving the sample dispensing probe 207 is realized by the control function 91 in the control circuitry 9. Specifically, the automatic analyzing apparatus 1 moves the sample dispensing probe 207 to the sample discharge position.

Subsequently, as illustrated in FIG. 10, the automatic analyzing apparatus 1 discharges the sample or the reagent (step S71). The processing of discharging the sample or the reagent is realized by the control function 91 in the control circuitry 9. Specifically, the automatic analyzing apparatus 1 causes the reaction container 2011 transported to the sample discharge position to discharge the sample or the reagent.

Subsequently, as illustrated in FIG. 10, the automatic analyzing apparatus 1 cleans the sample dispensing probe 207 (step S73). The processing of cleaning the sample dispensing probe 207 is realized by the control function 91 in the control circuitry 9. Specifically, the automatic analyzing apparatus 1 moves the sample dispensing probe 207 to a cleaning layer (not illustrated) to clean the sample dispensing probe 207.

After this step S73, after step S41 described above, after step S47 described above, after step S51 described above, or after step S63 described above, as illustrated in FIG. 10, the automatic analyzing apparatus 1 determines whether or not a next storage container 21 is present at the dispensing position (step S75). The processing of determining whether or not the next storage container 21 is present at the dispensing position is realized by the control function 91 in the control circuitry 9. Then, in a case where the next storage container 21 is not present at the dispensing position (step S75: No), the automatic analyzing apparatus 1 repeats step S75 and is on standby until the next storage container 21 is transported to the dispensing position.

On the other hand, in step S75, in a case where the next storage container 21 is present at the dispensing position (step S75: Yes), the automatic analyzing apparatus 1 returns to step S33 and executes the processing from step S33.

The dispensing control processing illustrated in FIG. 10 is repeatedly executed while the automatic analyzing apparatus 1 is activated, and is ended when the automatic analyzing apparatus 1 is stopped.

As described above, in accordance with the automatic analyzing apparatus 1 according to the present embodiment, the transport rack 22 includes the holder 2201, the first observation window 2203, and the second observation window 2204, and thus, the reading unit 216 included in the automatic analyzing apparatus 1 reads the identification information on the storage container 21 held by the holder 2201 via the first observation window 2203 and reads the observation result information of the sample or the reagent stored in the storage container 21 held by the holder 2201 via the second observation window 2204 at the dispensing standby position. Accordingly, it is possible to read the identification information and observe the liquid level of the sample before sampling. That is, in the present embodiment, the transport rack 22 includes the first slit 2203_1 of the first observation window 2203 and the second slit 2204_1 of the second observation window 2204. The reading unit 216 reads the identification information via the first slit 2203_1 and reads the observation result information via the second slit 2204_1 at the dispensing standby position before being transported to the dispensing position where the suction of the sample or the reagent is performed. Accordingly, it is possible to observe the liquid level of the sample or the liquid level of the reagent while the identification information is read, and it is possible to prevent occurrence of a sampling error in advance.

### Second Embodiment

In the automatic analyzing apparatus 1 according to the above-described first embodiment, although the first observation window 2203 in the transport rack 22 is configured by providing the first slit 2203_1 and the second observation window 2204 in the transport rack 22 is configured by providing the second slit 2204_1, the present invention is not limited thereto. In a second embodiment, a case where the transport rack 22 includes a transparent or translucent cover provided in at least one of the first slit 2203_1 and the second slit 2204_1 will be described. Hereinafter, portions different from the above-described first embodiment will be described. Note that, the configurations of the automatic analyzing apparatus 1 and the analysis mechanism 2 according to the first embodiment are similar to those in FIGS. 1 and 2, and thus, the description thereof will be omitted. Further, the configuration of the reading unit 216 and the other configurations are similar to those in FIGS. 5 to 8, and thus, the description thereof will be omitted. Further, F the contents of the reading processing and the dispensing control processing are similar to those in FIGS. 9 and 10, and thus, the description thereof will be omitted.

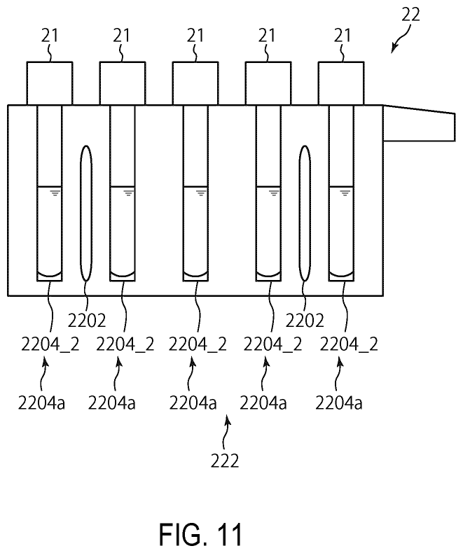

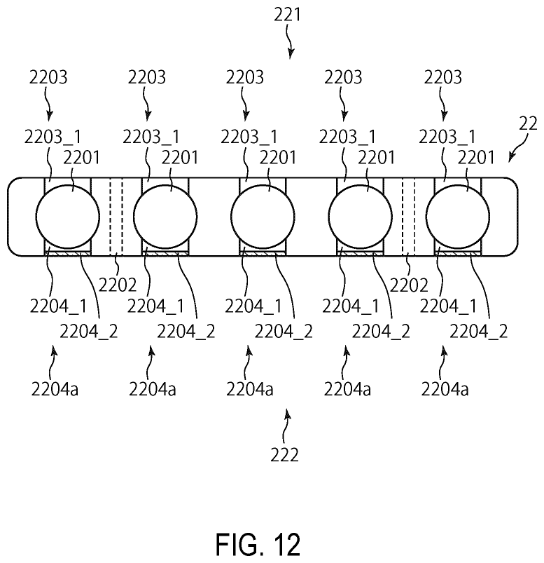

In the second embodiment, the transport rack 22 used in the analysis mechanism 2 will be described in detail with reference to FIGS. 11 and 12. FIG. 11 is a front view of the transport rack 22 used in the analysis mechanism illustrated in FIG. 2 in the present embodiment, and is a diagram corresponding to FIG. 3 in the above-described first embodiment. FIG. 12 is a plan view of the transport rack 22 used in the analysis mechanism 2 illustrated in FIG. 2 in the present embodiment, and is a diagram corresponding to FIG. 4 in the above-described first embodiment. As illustrated in FIGS. 11 and 12, the transport rack 22 according to the present embodiment includes the holders 2201, the transport arm connection units 2202, the first observation windows 2203, and a second observation windows 2204a. Note that, the configurations of the holder 2201 and the transport arm connection unit 2202 are similar to those of the first embodiment, and thus, the description thereof will be omitted.

The first observation window 2203 is an observation window that enables reading of identification information on the storage container 21 held by the holder 2201. As illustrated in FIGS. 11 and 12, the first observation window 2203 according to the present embodiment is formed by providing the rectangular first slit 2203_1 formed in the first side surface 221 of the transport rack 22. In addition, as illustrated in FIGS. 11 and 12, the first slit 2203_1 of the first observation window 2203 according to the present embodiment has a linear shape from the holder 2201 toward the first side surface 221.

The second observation window 2204a is an observation window that enables observation of the sample or the reagent stored in the storage container 21 held by the holder 2201. As illustrated in FIGS. 11 and 12, the second observation window 2204a according to the present embodiment is formed by providing the rectangular second slit 2204_1 formed in the second side surface 222 of the transport rack 22. In addition, as illustrated in FIGS. 11 and 12, the second observation window 2204a according to the present embodiment includes a cover 2204_2. The cover 2204_2 is provided by being attached to the second slit 2204_1, and is made of a transparent or translucent resin such as acrylic or polycarbonate in order to enable observation of the sample or the reagent stored in the storage container 21 held by the holder 2201 via the second slit 2204_1 and the cover 2204_2.

Note that, although the cover 2204_2 is provided by being attached to the second slit 2204_1, a method for providing the cover 2204_2 is not limited to the case of being attached to the second slit 2204_1. The cover 2204_2 may be provided by being fitted into a groove provided in the second slit 2204_1.

In addition, in the example illustrated in FIGS. 11 and 12, although the first observation window 2203 does not include the cover and includes the cover 2204_2 only in the second observation window 2204a, the configurations of the first observation window 2203 and the second observation window 2204a are not limited thereto. That is, the cover may be provided in at least one of the first slit 2203_1 and the second slit 2204_1. Thus, the first slit 2203_1 may include the cover, the second slit 2204_1 may not include the cover 2204_2, and both the first slit 2203_1 and the second slit 2204_1 may include the cover.

In addition, although the first slit 2203_1 and the second slit 2204_1 have the linear shape from the holder 2201 toward each side surface, the present invention is not limited thereto. The first slit 2203_1 and the second slit 2204_1 may have a tapered shape expanding from the holder 2201 toward each side surface.

Further, although the cover is made of the transparent or translucent resin, the material of the cover is not limited thereto. That is, the material of the cover is any material.

As described above, in accordance with the automatic analyzing apparatus 1 according to the second embodiment, it is possible to read the identification information and observe the liquid level of the sample before sampling as in the above-described first embodiment. That is, in the present embodiment, the transport rack 22 includes the first slit 2203_1 of the first observation window 2203 and the second slit 2204_1 of the second observation window 2204a, and includes the transparent or translucent cover in at least one of the first slit 2203_1 and the second slit 2204_1. The reading unit 216 reads the identification information via the first observation window 2203 and reads the observation result information via the second observation window 2204a at the dispensing standby position before being transported to the dispensing position where the suction of the sample or the reagent is performed. Accordingly, it is possible to observe the liquid level of the sample or the liquid level of the reagent while reading the identification information, and it is possible to prevent the occurrence of the sampling error in advance.

In addition, in accordance with the automatic analyzing apparatus 1 of the present embodiment, since the cover is provided in at least one of the first slit and the second slit, it is possible to improve the strength of the transport rack 22.

### Third Embodiment

In the automatic analyzing apparatus 1 according to the above-described first embodiment, although the first observation window 2203 in the transport rack 22 is configured by providing the first slit 2203_1, and the second observation window 2204 in the transport rack 22 is configured by providing the second slit 2204_1, the present invention is not limited thereto. In a third embodiment, a case where the first observation window 2203 and the second observation window 2204 are configured by forming, with a transparent or translucent material, one housing of a first housing in which the first observation window 2203 is provided and a second housing in which the second observation window is provided in the transport rack 22 and by providing slits in a side surface of the other housing of the first housing in which the first observation window 2203 is provided and the second housing in which the second observation window 2204 is provided will be described. Hereinafter, portions different from the above-described first embodiment will be described. Note that, the configurations of the automatic analyzing apparatus 1 and the analysis mechanism 2 according to the first embodiment are similar to those in FIGS. 1 and 2, and thus, the description thereof will be omitted. Further, the configuration of the reading unit 216 and the other configurations are similar to those in FIGS. 5 to 8, and thus, the description thereof will be omitted. Further, the contents of the reading processing and the dispensing control processing are similar to those in FIGS. 9 and 10, and thus, the description thereof will be omitted.

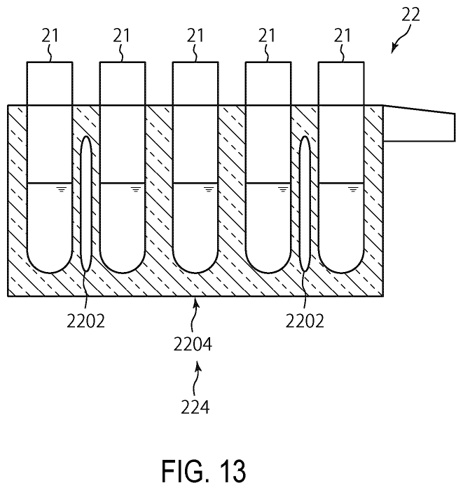

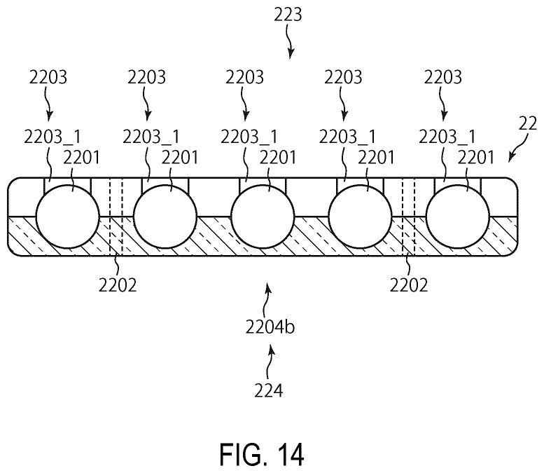

In the third embodiment, the transport rack 22 used in the analysis mechanism 2 will be described in detail with reference to FIGS. 13 and 14. FIG. 13 is a front view of the transport rack 22 used in the analysis mechanism illustrated in FIG. 2 in the present embodiment, and is a diagram corresponding to FIG. 3 in the above-described first embodiment. FIG. 14 is a plan view of the transport rack 22 used in the analysis mechanism 2 illustrated in FIG. 2 in the present embodiment, and is a diagram corresponding to FIG. 4 in the above-described first embodiment. As illustrated in FIGS. 13 and 14, the transport rack 22 according to the present embodiment is configured by coupling a first housing 223 and a second housing 224, and the transport rack 22 configured by coupling the first housing 223 and the second housing 224 includes the holder 2201, the transport arm connection unit 2202, the first observation window 2203, and a second observation window 2204b. Note that, the configuration of the transport arm connection unit 2202 is similar to that of the first embodiment, and thus, the description thereof is omitted.

The holder 2201 holds the storage container 21 in which the sample or the reagent is stored. As illustrated in FIG. 14, the holder 2201 according to the present embodiment is formed by coupling the first housing 223 and the second housing 224. In addition, as illustrated in FIG. 14, the holder 2201 according to the present embodiment is formed in a circular shape in plan view. Note that, although the holder 2201 according to the present embodiment is formed in the circular shape in plan view, the shape of the holder 2201 is not limited to the circular shape. That is, the shape of the holder 2201 is any shape, and may be, for example, a polygonal shape in plan view.

The first observation window 2203 is an observation window that enables reading of identification information on the storage container 21 held by the holder 2201. As illustrated in FIG. 14, the first observation window 2203 is provided in the first housing 223, and is configured by providing the rectangular first slit 2203_1 formed on the side surface of the first housing 223. In addition, as illustrated in FIG. 14, the first slit 2203_1 of the first observation window 2203 according to the present embodiment has a linear shape from the holder 2201 toward the side surface of the first housing 223.

The second observation window 2204b is an observation window that enables observation of the sample or the reagent stored in the storage container 21 held by the holder 2201. In addition, as illustrated in FIGS. 13 and 14, the second observation window 2204b according to the present embodiment is configured such that the second housing 224 is formed with a transparent or translucent resin such as acrylic or polycarbonate.

Note that, in the examples illustrated in FIGS. 13 and 14, although the first slit 2203_1 is provided in the first observation window 2203 and the second observation window 2204b is configured by forming, with the transparent or translucent material, the second housing 224, the configurations of the first observation window 2203 and the second observation window 2204b are not limited thereto. That is, the first observation window 2203 may be configured by forming, with the transparent or translucent material, the first housing 223, and may be configured by providing the second slit 2204_1 in the second observation window 2204b.

In addition, although the first housing 223 and the second housing 224 are formed with transparent or translucent resin, the materials of the first housing 223 and the second housing 224 are not limited thereto. That is, the material of the first housing 223 and the second housing 224 is any material, and may be, for example, a material such as transparent or translucent glass.

As described above, in accordance with the automatic analyzing apparatus 1 according to the third embodiment, it is possible to read the identification information and observe the liquid level of the sample before sampling as in the above-described first embodiment. That is, in the present embodiment, the transport rack 22 is configured by coupling the first housing 223 and the second housing 224, and the first observation window 2203 and the second observation window 2204 are configured by forming, with the transparent or translucent material, one housing of the first housing 223 and the second housing 224 and by providing the slits in the side surface of the other housing of the first housing 223 and the second housing 224. The reading unit 216 reads the identification information via the first observation window 2203 and reads the observation result information via the second observation window 2204 at the dispensing standby position. Accordingly, it is possible to observe the liquid level of the sample or the liquid level of the reagent while the identification information is read, and it is possible to prevent the occurrence of the sampling error in advance.

In addition, in accordance with the automatic analyzing apparatus 1 according to the present embodiment, the first observation window 2203 and the second observation window 2204 are configured by forming, with the transparent or translucent material, one housing of the first housing 223 and the second housing 224, and thus, it is not necessary to provide the slit in one housing of the first observation window 2203 and the second observation window 2204, and it is possible to improve the strength of the transport rack 22.

### Modified Example of Third Embodiment

In the automatic analyzing apparatus 1 according to the above-described third embodiment, although the first observation window 2203 or the second observation window 2204 is configured by forming, with the transparent or translucent material, one housing of the first housing 223 and the second housing 224 in the transport rack 22, the present invention is not limited thereto. In the transport rack 22, the holder 2201, the first observation window 2203, and the second observation window 2204 may be provided in a housing, and the first observation window 2203 and the second observation window 2204c may be configured by forming, with the transparent or translucent material, the housing.

### Fourth Embodiment

In the automatic analyzing apparatus 1 according to the above-described first embodiment, although the first observation window 2203 in the transport rack 22 is configured by providing the first slit 2203_1, and the second observation window 2204 in the transport rack 22 is formed by providing the second slit 2204_1, the present invention is not limited thereto. In a fourth embodiment, a case where at least one of the first slit 2203_1 and the second slit 2204_1 in the transport rack 22 is provided so as not to reach the upper surface of the transport rack 22 will be described. Hereinafter, portions different from the above-described first embodiment will be described. Note that, the configurations of the automatic analyzing apparatus 1 and the analysis mechanism 2 according to the first embodiment are similar to those in FIGS. 1 and 2, and thus, the description thereof will be omitted. Further, the configuration of the reading unit 216 and the other configurations are similar to those in FIGS. 5 to 8, and thus, the description thereof will be omitted. Further, the contents of the reading processing and the dispensing control processing are similar to those in FIGS. 9 and 10, and thus, the description thereof will be omitted.

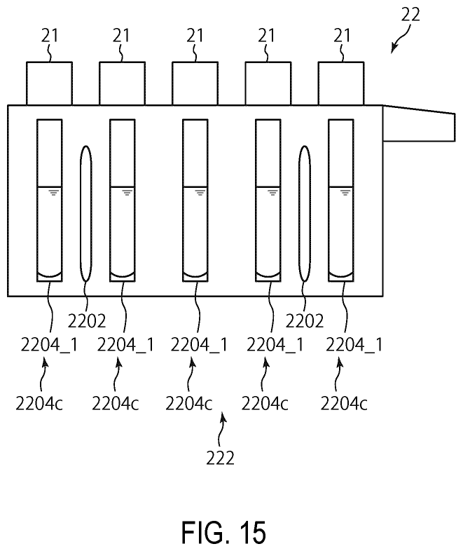

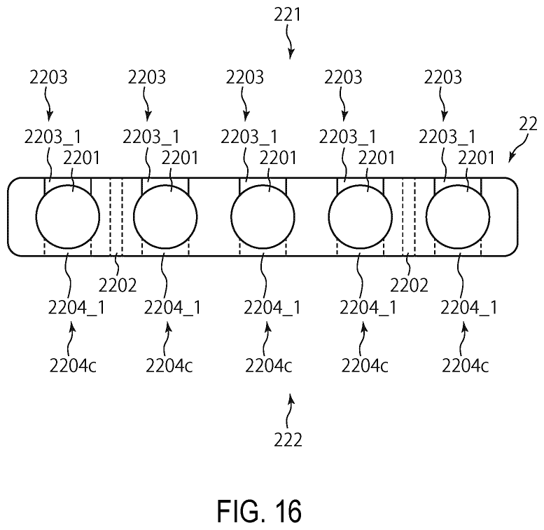

The transport rack 22 used in the analysis mechanism 2 in the fourth embodiment will be described in detail with reference to FIGS. 15 and 16. FIG. 15 is a front view of the transport rack 22 used in the analysis mechanism 2 illustrated in FIG. 2 in the present embodiment, and is a diagram corresponding to FIG. 3 in the above-described first embodiment. FIG. 16 is a plan view of the transport rack 22 used in the analysis mechanism 2 illustrated in FIG. 2 in the present embodiment, and is a diagram corresponding to FIG. 4 in the above-described first embodiment. As illustrated in FIGS. 15 and 16, the transport rack 22 according to the present embodiment includes the holders 2201, the transport arm connection units 2202, the first observation windows 2203, and second observation windows 2204c. Note that, the configurations of the holder 2201 and the transport arm connection unit 2202 are similar to those of the first embodiment, and thus, the description thereof will be omitted.

The first observation window 2203 is an observation window that enables reading of identification information present in the storage container 21 held by the holder 2201. As illustrated in FIGS. 15 and 16, the first observation window 2203 according to the present embodiment is formed by providing the rectangular first slit 2203_1 formed in the first side surface 221 of the transport rack 22. In addition, as illustrated in FIGS. 15 and 16, the first slit 2203_1 of the first observation window 2203 according to the present embodiment has a linear shape from the holder 2201 toward the first side surface 221.

The second observation window 2204c is an observation window that enables observation of the sample or the reagent stored in the storage container 21 held by the holder 2201. As illustrated in FIGS. 15 and 16, the second observation window 2204c according to the present embodiment is formed by providing the rectangular second slit 2204_1 formed in the second side surface 222 of the transport rack 22. In addition, as illustrated in FIGS. 15 and 16, the second slit 2204_1 of the second observation window 2204c according to the present embodiment has a linear shape from the holder 2201 toward the second side surface 222. In addition, as illustrated in FIGS. 15 and 16, in the second observation window 2204c according to the present embodiment, the second slit 2204_1 is provided so as not to reach the upper surface of the transport rack 22. That is, the second observation window 2204c according to the present embodiment is provided by connecting an upper portion of the second slit 2204_1.

Note that, in the example illustrated in FIGS. 15 and 16, although the first slit 2203_1 of the first observation window 2203 is provided so as to reach the upper surface of the transport rack 22 and the second slit 2204_1 of the second observation window 2204c is provided so as not to reach the upper surface of the transport rack 22, the configurations of the first observation window 2203 and the second observation window 2204c are not limited thereto. That is, at least one of the first slit 2203_1 and the second slit 2204_1 may be provided so as not to reach the upper surface of the transport rack 22. Thus, the first slit 2203_1 of the first observation window 2203 may be provided so as not to reach the upper surface of the transport rack 22, the second slit 2204_1 of the second observation window 2204c may be provided so as to reach the upper surface of the transport rack 22, or both the first slit 2203_1 and the second slit 2204_1 may be provided so as not to reach the upper surface of the transport rack 22.

In addition, although the first slit 2203_1 and the second slit 2204_1 have the linear shape from the holder 2201 toward each side surface, the present invention is not limited thereto. The first slit 2203_1 and the second slit 2204_1 may have a tapered shape expanding from the holder 2201 toward each side surface.

As described above, in accordance with the automatic analyzing apparatus 1 according to the fourth embodiment, it is possible to read the identification information and observe the liquid level of the sample before sampling as in the above-described first embodiment. That is, in the present embodiment, the transport rack 22 includes the first slit 2203_1 of the first observation window 2203 and the second slit 2204_1 of the second observation window 2204c, at least one of the first slit 2203_1 and the second slit 2204_1 is provided so as not to reach the upper surface of the transport rack 22. The reading unit 216 reads the identification information via the first observation window 2203 and reads the observation result information via the second observation window 2204c at the dispensing standby position before being transported to the dispensing position where the suction of the sample or the reagent is performed. Accordingly, it is possible to observe the liquid level of the sample or the liquid level of the reagent while the identification information is read, and it is possible to prevent occurrence of a sampling error in advance.

In addition, in accordance with the automatic analyzing apparatus 1 of the present embodiment, at least one of the first slit 2203_1 and the second slit 2204_1 is provided so as not to reach the upper surface of the transport rack 22. That is, since the upper portion of at least one of the first slit 2203_1 and the second slit 2204_1 is connected, it is possible to improve the strength of the transport rack 22.

### Modified Examples of First to Fourth Embodiments

In the automatic analyzing apparatus 1 according to the first to fourth embodiments described above, the reading unit 216 may include a barcode reader instead of the first imaging device. That is, the reading unit 216 may read the identification information by the barcode reader via the first observation window 2203 and may read the observation result information by the second imaging device via the second observation window.

In addition, in the automatic analyzing apparatus 1 according to the first to fourth embodiments described above, the reading unit 216 may include barcode readers in addition to the first imaging device and the second imaging device. That is, the reading unit 216 may read the identification information by the first imaging device and/or the barcode reader via the first observation window 2203, and may read the observation result information by the second imaging device and/or the barcode reader via the second observation window 2204.

In addition, in the automatic analyzing apparatus 1 according to the first to fourth embodiments described above, after the reading unit 216 reads the identification information and the observation result information at the dispensing standby position, the automatic analyzing apparatus 1 transports the transport rack 22 to the dispensing position by the drive mechanism 4. However, the reading unit 216 may read the identification information and the observation result information at the dispensing position. That is, the reading unit 216 may read the identification information and the observation result information before sampling at the dispensing position, and may execute the dispensing control processing after reading the identification information and the observation result information.

In addition, in the automatic analyzing apparatus 1 according to the first to fourth embodiments described above, although the suction of the sample or the reagent stored in the storage container 21 is performed by the sample dispensing probe 207, the suction of the sample or the reagent stored in the storage container 21 is not limited to the sample dispensing probe 207. That is, the probe that sucks the sample or the reagent stored in the storage container 21 is any probe, and for example, may be performed by the first reagent dispensing probe 209, the second reagent dispensing probe 211, or the like at the dispensing position. Further, another dispensing probe other than the sample dispensing probe 207, the first reagent dispensing probe 209, and the second reagent dispensing probe 211 is provided, and thus, the suction of the sample stored in the storage container 21 may be performed by the sample dispensing probe 207. The suction of the reagent stored in the storage container 21 may be performed by another dispensing probe.

In the dispensing control processing in the automatic analyzing apparatus 1 according to the above-described first to fourth embodiments, although the dispensing is stopped in step S51 in a case where the state of the sample or the state of the reagent is the predetermined state, the present invention is not limited thereto. That is, in the dispensing control processing, even in a case where the state of the sample or the state of the reagent is the predetermined state, the processing in and after step S53 may be performed by generating additional information for adding information indicating that the state of the sample or the state of the reagent is the predetermined state to the test information and adding the additional information to the test information.

In addition, in the dispensing control processing in the automatic analyzing apparatus 1 according to the above-described first to fourth embodiments, in a case where the observation result information acquired in step S43 includes the liquid level state information, and in a case where there is an air bubble on the liquid level of the sample stored in the storage container 21 or the liquid level of the reagent in the liquid level state information by the control function 91, the automatic analyzing apparatus 1 controls the sample dispensing probe 207 based on the liquid level state information. Specifically, the control function 91 lowers the sample dispensing probe 207 so as to avoid the air bubble on the liquid level of the sample or the liquid level of the reagent based on the liquid level state information. As a result, even in a case where the liquid level is detected by the liquid level detection method using the electrostatic capacitance, the liquid level of the sample or the liquid level of the reagent can be detected without erroneously detecting the air bubble as the liquid level.

Further, although the application of the automatic analyzing apparatus 1 according to the above-described first to fourth embodiments to an automatic analyzing apparatus that performs a biochemical test has been described, the present invention is not limited thereto. That is, the first to fourth embodiments can also be applied to an automatic analyzing apparatus that performs a blood coagulation analysis test.

Note that the word “processor” used in above descriptions means circuits such as, for example, a Central Processing Unit (CPU), a Graphics Processing Unit (GPU), an Application Specific Integrated Circuit (ASIC), a programmable logic device (for example, a Simple Programmable Logic Apparatus (SPLD), a Complex Programmable Logic Apparatus (CPLD), and a Field Programmable Gate Array (FPGA)). The processor executes functions by reading and executing programs stored in the memory 8. Note that programs may be configured to be directly integrated in the processor instead of being storing in the memory 8. In this case, the processor realizes functions by reading and executing programs stored in the circuitry. Note that the processor is not limited to the case arranged as a single processor circuit, but may be configured as a single processor by combining a plurality of independent circuits to realize functions. Furthermore, a plurality of component elements may be integrated into one processor to realize the functions.

While certain embodiments have been described, these embodiments have been presented by way of example only and are not intended to limit the scope of the inventions. The embodiments may be in a variety of other forms. Furthermore, various omissions, substitutions and changes may be made without departing from the spirit of the inventions. The embodiments and their modifications are included in the scope and the subject matter of the invention, and at the same time included in the scope of the claimed inventions and their equivalents.

1. A transport rack, comprising:
a holder configured to hold a storage container that stores a sample or a reagent that is reacted with the sample;
a first observation window configured to enable reading of identification information on the storage container; and
a second observation window configured to enable observation of the sample or the reagent stored in the storage container.

2. The transport rack according to claim 1, wherein:
the first observation window is configured to provide a first slit in a first side surface of the transport rack, and a first slit being formed from the holder toward a first side surface of the transport rack; and
the second observation window is configured to provide a second slit in a second side surface opposite to the first side surface of the transport rack, and the second slit being formed from the holder toward the second side surface of the transport rack.

3. The transport rack according to claim 2, further comprising a transparent or translucent cover that is provided in at least one of the first slit and the second slit.

4. The transport rack according to claim 2, wherein at least one of the first slit and the second slit has a tapered shape expanding from the holder toward each side surface of the transport rack.

5. The transport rack according to claim 2, wherein at least one of the first slit and the second slit is provided so as not to reach an upper surface of the transport rack.

6. The transport rack according to claim 1, wherein:
the holder is formed by coupling a first housing in which the first observation window is provided and a second housing in which the second observation window is provided; and
the first observation window and the second observation window are configured by forming, with a transparent or translucent material, one housing of the first housing and the second housing and by providing slits in a side surface of the other housing of the first housing and the second housing.

7. The transport rack according to claim 1, wherein:
the holder, the first observation window, and the second observation window are provided in a housing, and
the first observation window and the second observation window are configured by forming, with a transparent or translucent material, the housing.

8. An automatic analyzing apparatus, comprising:
an information reader configured to read identification information on a storage container held by a transport rack via a first observation window and read observation result information via a second observation window, the storage container storing a sample or a reagent that is reacted with the sample, the transport rack transporting the storage container, the first observation window enabling reading of the identification information, the observation result information being an observation result of the sample or the reagent stored in the storage container, and the second observation window enabling observation of the sample or the reagent stored in the storage container held by the transport rack;
a dispensing probe configured to suck the sample or the reagent stored in the storage container; and
a processing circuitry configured to control the dispensing probe based on the identification information and the observation result information.

9. The automatic analyzing apparatus according to claim 8, wherein the information reader comprises:
a first reader configured to read the identification information via the first observation window; and
a second reader configured to read the observation result information via the second observation window.

10. The automatic analyzing apparatus according to claim 8, wherein the information reader comprises:
a reader configured to read the identification information via the first observation window and read the observation result information via the second observation window;
a first reflector that is provided at a position facing the first observation window, and is configured to form a first optical path between the first observation window and the reader; and
a second reflector that is provided at a position facing the second observation window, and is configured to form a second optical path between the second observation window and the reader.

11. The automatic analyzing apparatus according to claim 8, wherein the information reader is configured to read the identification information and the observation result information in a case where the storage container is transported to a dispensing standby position before the storage container is transported to a dispensing position, the dispensing standby position being a position where the storage container is on standby for dispensing the sample or dispensing the reagent, and the dispensing position being a position where suction of the sample or suction of the reagent is performed.

12. The automatic analyzing apparatus according to claim 9, wherein:
the processing circuitry is further configured to analyze image data generated by the information reader; and
the information reader is configured to read the observation result information by imaging the sample or the reagent stored in the storage container, generating the image data, and causing the processing circuitry to analyze the image data.

13. The automatic analyzing apparatus according to claim 12, wherein the information reader is configured to read the identification information by imaging the identification information on the storage container, generating the image data, and causing the processing circuitry to analyze the image data.

14. The automatic analyzing apparatus according to claim 8, wherein the processing circuitry is further configured to:
calculate storage amount information regarding an amount of the sample or an amount of the reagent stored in the storage container based on the observation result information read by the information reader;
determine whether or not there is an amount of the sample or an amount of the reagent necessary for a test in the storage container based on test information and the storage amount information, and the test information being information regarding the test of the sample based on the identification information; and
notify that the amount of sample or the amount of reagent is insufficient in a case where it is determined that there is not the amount of sample or the amount of reagent necessary for the test in the storage container.

15. The automatic analyzing apparatus according to claim 8, wherein:
the observation result information includes liquid level positional information regarding a liquid level position of the sample or a liquid level position of the reagent stored in the storage container; and
the processing circuitry is further configured to lower the dispensing probe based on the liquid level positional information, and control the dispensing probe to lower the dispensing probe by a predetermined amount in a case where a liquid level of the sample or a liquid level of the reagent stored in the storage container is not detected.

16. The automatic analyzing apparatus according to claim 15, wherein the processing circuitry is further configured to:
lower the dispensing probe by the predetermined amount, and lower the dispensing probe by a predetermined amount again in a case where the sample or the reagent stored in the storage container is not detected and in a case where a number of times the dispensing probe is lowered by the predetermined amount is less than a predetermined number of times; and
lower the dispensing probe by the predetermined amount, and notify that the liquid level of the sample or the reagent stored in the storage container is not detected in a case where the sample or the reagent stored in the storage container is not detected and in a case where the number of times the dispensing probe is lowered by the predetermined amount reaches the predetermined number of times.

17. The automatic analyzing apparatus according to claim 14, wherein:
the observation result information includes color information regarding color of the sample or color of the reagent stored in the storage container; and
the processing circuitry is further configured to:
determine whether or not a state of the sample or a state of the reagent stored in the storage container is a predetermined state based on the color information; and
stop the dispensing of the sample or the dispensing of the reagent stored in the storage container in a case where the state of the sample or the state of the reagent stored in the storage container is the predetermined state.

18. The automatic analyzing apparatus according to claim 17, wherein the processing circuitry is further configured to determine a type of the sample or a type of the reagent stored in the storage container based on the color information.

19. The automatic analyzing apparatus according to claim 8, wherein:
the observation result information includes liquid level state information regarding a liquid level state of the sample or a liquid level state of the reagent stored in the storage container; and
the processing circuitry is further configured to control the dispensing probe based on the liquid level state information in a case where there is an air bubble on a liquid level of the sample or a liquid level of the reagent stored in the storage container by the liquid level state information.

20. An automatic analyzing system comprising:
a transport rack configured to hold a storage container that stores a sample or a reagent that is reacted with the sample; and
an automatic analyzing apparatus configured to analyze the sample by using the sample or the reagent stored in the storage container held by the transport rack,
wherein the transport rack comprises:
a holder configured to hold the storage container that stores the sample or the reagent that is reacted with the sample;
a first observation window configured to enable reading of identification information on the storage container; and
a second observation window configured to enable observation of the sample or the reagent stored in the storage container; and
wherein the automatic analyzing apparatus comprises:
an information reader configured to read the identification information via the first observation window and read observation result information via the second observation window, and the observation result information being an observation result of the sample or the reagent stored in the storage container held by the transport rack;
a dispensing probe configured to suck the sample or the reagent stored in the storage container; and
the processing circuitry configured to control the dispensing probe based on the identification information and the observation result information.
